(19) United States
(12) Patent Application Publication
(10) Pub. No.: US 2017/0176929 A1
(43) Pub. Date: Jun. 22, 2017

(54) Electrophotographic Imaging Apparatus with a Conditioning Unit and/or a Fusing Unit

(71) Applicant: Xeikon IP B.V., Eede (NL)

(72) Inventors: Herman Jan Godelieve Van de Straete, Deurne (BE); Thomas Praet, Rumst (BE); Niels Peter Ingo Van der Gucht, Lint (BE); Marcus Hoppe, Willebroek (BE)

(21) Appl. No.: 15/379,832

(22) Filed: Dec. 15, 2016

(30) Foreign Application Priority Data
Dec. 16, 2015 (NL) 2015973

(51) Int. Cl. G03G 15/00

(52) U.S. Cl. CPC G03G 21/206; H05B 3/0066

(57) ABSTRACT

An electrophotographic imaging apparatus includes a conditioning unit configured to heat a substrate; and an image forming unit configured to develop an image and to transfer the developed image to the heated substrate. The image forming unit is located downstream of the conditioning unit. The conditioning unit is configured to emit radiation having a wavelength between 1 micrometre and 5 micrometre, to the substrate. The conditioning unit includes at least one infrared radiator which is configured to operate at a temperature between 500 and 2500 degrees Celsius.

### CROSS-REFERENCE TO RELATED APPLICATION

This application claims priority to Netherlands Patent Application No. 2015973 filed Dec. 16, 2015, the disclosure of which is hereby incorporated in its entirety by reference.

### FIELD OF INVENTION

The field of the invention relates to the field of electrophotographic imaging apparatus. Particular embodiments relate to an electrophotographic imaging apparatus with a conditioning unit and/or a fusing unit.

### BACKGROUND

Electrophotographic imaging is well known. In electrophotography, electrophotographic imaging members have a photoconductive surface layer which functions as an insulator so that during the imaging process, electric charges can be retained on its surface. The photoconductive insulating layer is first uniformly electrostatically charged. The imaging member is then exposed to a pattern of electromagnetic radiation, to create an electrostatic latent image on the non-illuminated areas. This electrostatic latent image may then be developed to form a visible image by depositing marking particles on the surface of the photoconductive insulating layer. The resulting visible image may then be transferred from the imaging member directly or indirectly to substrate, such as paper. Such image forming devices include, but are not limited to, printers, copiers, scanners, multi-function devices and other like systems capable of producing and reproducing image data from an original document, data file or the like.

Moisture content in paper substrates has been found to be a major contributing factor to defects in printed images on paper substrates. Moisture in the material matrix of the paper, and in particular a non-uniform distribution of moisture has been found to degrade and impede toner-imaging capabilities. Moisture content difference between different portions of the substrate will cause non-uniformities in the printed image. Further, for thick paper the moisture content should be sufficient, i.e. the paper may not be too dry, in order to have a sufficiently high conductivity of the paper substrate.

It is known to address the above mentioned problems by conditioning, and in particular by heating the paper substrate before printing. In existing embodiments heating rollers are used to heat the paper substrate before printing. Such rollers are typically heated up to a temperature of 100° C. to 200° C. Such rollers have the disadvantage of having a large heat capacity and are therefore difficult to control. Indeed, there will be needed a certain amount of time to heat/cool the rollers. Also, it is difficult to control the distribution of the moisture content using such heating rollers.

### SUMMARY OF THE INVENTION

Embodiments of the invention aim to provide an electrophotography imaging apparatus with improved conditioning of substrates containing paper.

According to a first aspect of the invention there is provided an electrophotographic imaging apparatus comprising a conditioning unit configured to heat a substrate and an image forming unit configured to develop an image and to transfer the developed image to the heated substrate. The image forming unit is located downstream of the conditioning unit. The conditioning unit is configured to emit radiation having wavelengths between 1 micrometre and 5 micrometre, to the substrate, wherein said conditioning unit comprises at least one infrared radiator which is configured to operate at a temperature between 500 and 2500 degrees Celsius.

Embodiments of the invention are based inter alia on the inventive insight that, above a predetermined threshold wavelength, the radiation absorption of the substrate increases with the wavelength. The specified operation range of the conditioning unit will allow obtaining on the one hand a sufficient amount of total radiated power (proportional with T⁴, wherein T is the temperature of the IR radiator in Kelvin) with a relatively compact conditioning unit, whilst at the same time achieving a relatively high absorption of the radiation in the substrate. Also, because the conditioning unit can have a radiating body with a relatively small mass and large surface, the heat capacity of the conditioning unit can be very low, so that the time needed to switch on/off the conditioning unit can be very low.

In an exemplary embodiment the conditioning unit is configured to emit radiation having a peak radiation wavelength

$${λ}_{max} = \frac{2900 µm . K}{T}$$

between 1.4 micrometre and 5 micrometre, preferably between 2 and 4 micrometre, more preferably between 2.2 and 3.8 micrometre. In this formula T represents the temperature in Kelvin.

In an exemplary embodiment the conditioning unit comprises at least one infrared radiator which is configured to operate at a temperature between 500 and 2500 degrees Celsius, preferably between 500 and 1500 degrees Celsius, and more preferably between 550 and 1000 degrees Celsius.

In an exemplary embodiment the at least one infrared radiator comprises a metal body configured to emit radiation when a voltage is applied over the metal body, i.e. a resistive heater, wherein in operation the temperature of the metal body is as specified above. The metal body may be a metal sheet or a plurality of interconnected sheet strips, lanes or band, optionally coated. In exemplary embodiments the thickness of the metal sheet or strips is smaller than 2 mm, preferably smaller than 1 mm, and more preferably smaller than 0.5 mm. In an exemplary embodiment the metal body comprises a pattern with a plurality of strips connected in series, wherein the plurality of strips has a width between 5 mm and 20 mm, and the total length of the plurality of strips is larger than 1 m. Preferably the pattern is such that the strips create a more or less rectangular radiating surface. The advantage of a metal sheet is that the radiating surface may be relatively large compared to the volume of the metal body. In an alternative embodiment the metal body may be metal wires, optionally coated metal wires. Such embodiments will allow having a relatively small heat capacity per surface area seen by the substrate, so that the temperature of the metal body can decrease fast when switching off the power supply.

In an exemplary embodiment the conditioning unit comprises a converter circuit for converting a mains voltage in an alternating voltage/current for powering the at least one infrared radiator, and a regulator for regulating a duty cycle of the alternating voltage/current.

In an exemplary embodiment the electrophotographic imaging apparatus further comprises at least one sensor configured for measuring a value representative for moisture content in the print substrate before and/or after the print substrate has passed through the conditioning unit, and a controller configured to control the conditioning unit in function of the measured value by the at least one sensor. In that manner the moisture content may be controlled accurately, taking into account the fast response time of the conditioning unit.

According to a second aspect of the invention there is provided an electrophotographic imaging apparatus comprising a conditioning unit configured to heat a substrate, an image forming unit configured to develop an image and to transfer the developed image to the heated substrate, and at least a first sensor and a second sensor configured for measuring values representative for moisture content in the print substrate at a first location and at a second location, respectively. The image forming unit is located downstream of the conditioning unit. The first location is at a distance of the second location seen in a transverse direction perpendicular on a movement direction of the substrate through the electrophotographic imaging apparatus. The conditioning unit comprises at least a first heater and a second heater located adjacently of each other seen in the transverse direction. The apparatus further comprises a controller configured to control the first and second heater in function of the measured values by the first and second sensor.

By providing a first and second infrared radiators adjacent to each other seen in the transverse direction of the substrate, and by providing a controller which can control those infrared radiators independently, differences in moisture content in the substrate can be adequately corrected. The inventors discovered that, e.g. due to storage of substrate rolls in a vertical position, the moisture content may vary significantly in the transverse direction of the substrate. Using embodiments of the invention, these differences between moisture content can be compensated by adjusting the heating by the first and second infrared radiators, such that parts of the substrate with the highest moisture content are heated more than parts of the substrate with the lowest moisture content.

In an exemplary embodiment the first and second sensor are configured for measuring values representative for moisture content in the substrate between the conditioning unit and the image forming unit. In another exemplary embodiment the first and second sensor are configured for measuring values representative for moisture content in the substrate upstream of the conditioning unit. There may also be provided a series of sensors at various locations along the printing substrate path followed by the substrate.

In an exemplary embodiment the conditioning unit is configured to emit radiation having a wavelength between 1 micrometre and 5 micrometre, to the substrate, wherein the first and second heater are a first and second infrared radiator which are configured to operate at a temperature between 500 and 2500 degrees Celsius. In an exemplary embodiment the conditioning unit is configured to emit radiation having a peak radiation wavelength between 1.4 micrometre and 5 micrometre, preferably between 2 and 4 micrometre. In an exemplary embodiment the first and second infrared radiators are configured to operate at a temperature between 500 and 1500 degrees Celsius, preferably between 550 and 1000 degrees Celsius.

In an exemplary embodiment the first and second infrared radiator each comprise a resistive heater with a metal sheet, optionally a coated metal sheet. In other embodiments the first and second infrared radiator each comprise an IR lamp, e.g. a carbon IR lamp or a fast response medium wave (FRMW) IR lamp.

In an exemplary embodiment the conditioning unit comprises a first and second converter circuit for converting a mains voltage in an alternating voltage/current for powering the first and second IR radiator, respectively, and a first and second regulator for regulating a duty cycle of the alternating voltage/current.

According to a third aspect of the invention there is provided an electrophotographic imaging apparatus comprising an image forming unit configured to develop an image and to transfer the developed image to a substrate, and a fusing unit configured to fuse the transferred image on the substrate. The fusing unit is configured to emit radiation having a wavelength between 1 micrometre and 5 micrometre, to the substrate. The fusing unit comprises at least one infrared radiator which is configured to operate at a temperature between 500 and 1200 degrees Celsius.

In that manner a very compact and efficient fusing unit is obtained which is well controllable and can be quickly turned on/off. In the specified operating range the absorption in a paper substrate is good and there are no significant differences between the fusing of different colours. Indeed, for temperatures above 1200 degrees Celsius, the absorption and reflection properties between colour (CMY) and black (K) are different which may lead to deficiencies in the fusing results.

In an exemplary embodiment, the electrophotographic imaging apparatus may have features of the electrophotographic imaging apparatus disclosed in patent application PCT/NL2015/050461 in the name of the Applicant, the content of which is included herein by reference.

In an exemplary embodiment the fusing unit is configured to emit radiation having a peak radiation wavelength

$${λ}_{max} = \frac{2900 µm . K}{T}$$

between 1.4 micrometre and 5 micrometre, preferably between 1.9 and 4 micrometre.

In an exemplary embodiment the fusing unit comprises at least one infrared radiator which is configured to operate at a temperature between 500 and 2500 degrees Celsius, preferably between 500 and 1500 degrees Celsius, and more preferably between 550 and 1000 degrees Celsius. The at least one infrared radiator may comprise e.g. a resistive heater with a metal sheet, optionally a coated metal sheet. In other embodiments IR lamps may be used.

In an exemplary embodiment the fusing unit comprises a converter circuit for converting a mains voltage in an alternating voltage/current that is applied over/through a metal body of the infrared radiator; and a regulator for regulating a duty cycle of the alternating voltage/current.

In an exemplary embodiment the electrophotographic imaging apparatus further comprises at least one sensor and a controller. The at least one sensor is configured for measuring a value representative for a property of the print substrate before and/or after the print substrate has passed through the fusing unit, and may be e.g. a temperature sensor and/or a moisture content sensor. The controller is configured to control the fusing unit in function of the measured value by the at least one sensor. In that manner, if the temperature is too high, the controller may control the at least one infrared radiator such that intensity of the at least one infrared radiator may be decreased, and vice versa.

In an exemplary embodiment at least a first and a second sensor configured for measuring values representative for a property of the print substrate, are provided at a distance of each other seen in a transverse direction perpendicular on a movement direction of the substrate through the electrophotographic imaging apparatus; wherein the fusing unit comprises at least a first infrared radiator and a second infrared radiator located adjacently of each other seen in the transverse direction; and wherein the controller is configured to control the first and second infrared radiator in function of the measured values by the first and second sensor.

In an exemplary embodiment the fusing unit comprises at least a first infrared radiator and a second infrared radiator located behind each other seen in a movement direction of the substrate through the electrophotographic imaging apparatus. A controller may then be configured to control the first infrared radiator and the second infrared radiator in function of the measured value by the at least one sensor. Such an embodiment with a number of infrared radiators in series may be advantageous if it is better to fuse with a lower intensity or with a gradually increasing intensity.

In another exemplary embodiment at least a first and a second sensor configured for measuring values representative for a property of the print substrate, e.g. a first and second temperature sensor, are provided at a distance of each other seen in a transverse direction perpendicular on a movement direction of the substrate through the electrophotographic imaging apparatus. The fusing unit comprises at least a first infrared radiator and a second infrared radiator located adjacently of each other seen in the transverse direction. The controller is configured to control the first and second infrared radiator in function of the measured values by the first and second sensor. Yet other variants may use an array of infrared radiators which are independently controllable by the controller in function of values measured by the sensors.

In an exemplary embodiment the at least one infrared radiator of the fusing unit has a heat capacity per surface area seen by the substrate between 50 and 2000 J/m²K, preferably between 50 and 1500 J/m²K, more preferably between 50 and 1000 J/m²K. Such a heat capacity is sufficiently low for allowing a fast switching on and off of the at least one infrared radiator.

According to a fourth aspect of the invention there is provided an electrophotographic imaging apparatus comprising: a fusing unit configured to heat a substrate; an image forming unit configured to develop an image and to transfer the developed image to the heated substrate, said image forming unit being located downstream of the conditioning unit; at least a first sensor and a second sensor; and a controller. The first and second sensor are configured for measuring values representative for a property of the print substrate at a first location and at a second location, respectively, wherein the first location is at a distance of the second location seen in a transverse direction perpendicular on a movement direction of the substrate through the electrophotographic imaging apparatus. The fusing unit comprises at least a first heater and a second heater located adjacently of each other seen in the transverse direction. The controller is configured to control the first and second heater in function of the measured values by the first and second sensor.

In an exemplary embodiment thereof the first and second sensor are configured for measuring values representative for a property in the substrate downstream or upstream of the fusing unit. The first and second sensors may be e.g. temperature sensors and/or moisture content sensors, i.e. sensors configured for measuring a value representative for moisture content in the print substrate.

In an exemplary embodiment thereof the fusing unit is configured to emit radiation having a wavelength between 1 micrometre and 5 micrometre, to the substrate, wherein the first and second heater are a first and second infrared radiator which are configured to operate at a temperature between 500 and 1200 degrees Celsius. More specifically, the fusing unit may be configured to emit radiation having a peak radiation wavelength between 1.4 micrometre and 5 micrometre, preferably between 1.9 and 4 micrometre.

In an exemplary embodiment the first and second infrared radiator each comprise a resistive heater with a metal sheet, or with a plurality of interconnected metal strips or bands, or with a metal wire optionally coated. The metal body may further have the features described above for the metal body of the conditioning unit.

In an exemplary embodiment thereof the fusing unit comprises a first and second converter circuit for converting a mains voltage in an alternating voltage/current for powering the first and second infrared radiator, respectively; and a first and second regulator for regulating a duty cycle of the alternating voltage/current.

In an exemplary embodiment, which may be applicable for the various aspects mentioned above, the image forming unit is configured for using a liquid toner.

In an exemplary embodiment the conditioning unit or the fusing unit may further comprise a blowing unit to cool the one or more infrared radiators when the conditioning unit or the fusing unit is switched off. This will allow to further decrease the time needed to bring the conditioning unit or the fusing unit at a safe temperature.

### BRIEF DESCRIPTION OF THE DRAWINGS

The accompanying drawings are used to illustrate presently preferred non-limiting exemplary embodiments of devices of the present invention. The above and other advantages of the features and objects of the invention will become more apparent and the invention will be better understood from the following detailed description when read in conjunction with the accompanying drawings, in which:

FIG. 1 illustrates schematically an exemplary embodiment of an electrophotographic imaging apparatus;

FIG. 2A illustrates schematically an exemplary embodiment of an electrophotographic imaging apparatus using liquid toner;

FIG. 2B illustrates schematically an exemplary embodiment of an electrophotographic imaging apparatus using dry toner;

FIG. 3 illustrates schematically an embodiment of a conditioning unit for use in an electrophotographic imaging apparatus;

FIG. 4 is a schematic view of an exemplary embodiment of an infrared radiator for use in embodiments of the invention; and

FIG. 5 is a graph plotting the radiation absorption by the substrate in function of the wavelength for various types of paper substrates.

### DETAILED DESCRIPTION

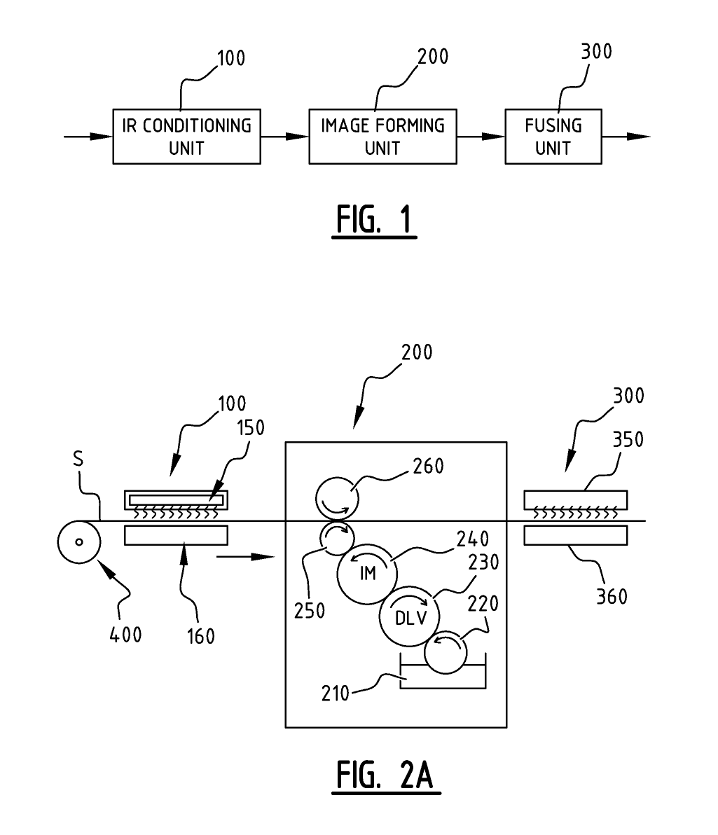

FIG. 1 illustrates an electrophotographic imaging apparatus comprising a conditioning unit 100, an image forming unit 200, and a fusing unit 300. A substrate on which an image is to be printed is first conveyed through the conditioning unit 100 to heat the substrate. The image forming unit 200 is configured to develop an image and to transfer the developed image to the heated substrate that has been conveyed through the conditioning unit 100. Next, the substrate with the transferred image passes through a fusing unit 300 in order to obtain a good adherence of the transferred image to the substrate.

The conditioning unit 100 is configured to emit radiation having a wavelength between 1 μm and 5 μm onto the substrate. The conditioning 100 comprises at least one infrared radiator which is configured to operate at a temperature between 500° C. and 2500° C., preferably between 500° C. and 1500° C., more preferably between 550° C. and 1000° C., and even more preferably between 600° C. and 900° C. According to the law of Stefan-Boltzmann the total radiated power is proportional with the surface of the radiator and the temperature T, and more in particular proportional with T⁴. In other words, the higher the temperature, the higher the total radiated power. However, the spectral energy density is a function of the wavelength, and the peak value for which the spectral density is maximal occurs at a wavelength λₘₐₓ which is temperature-dependent, as determined by Wien's law:

λₘₐₓ·T=2900 μm·K

In other words, for 500° C. λₘₐₓ=3.75 μm, and for 2500° C. λₘₐₓ=1.05 μm.

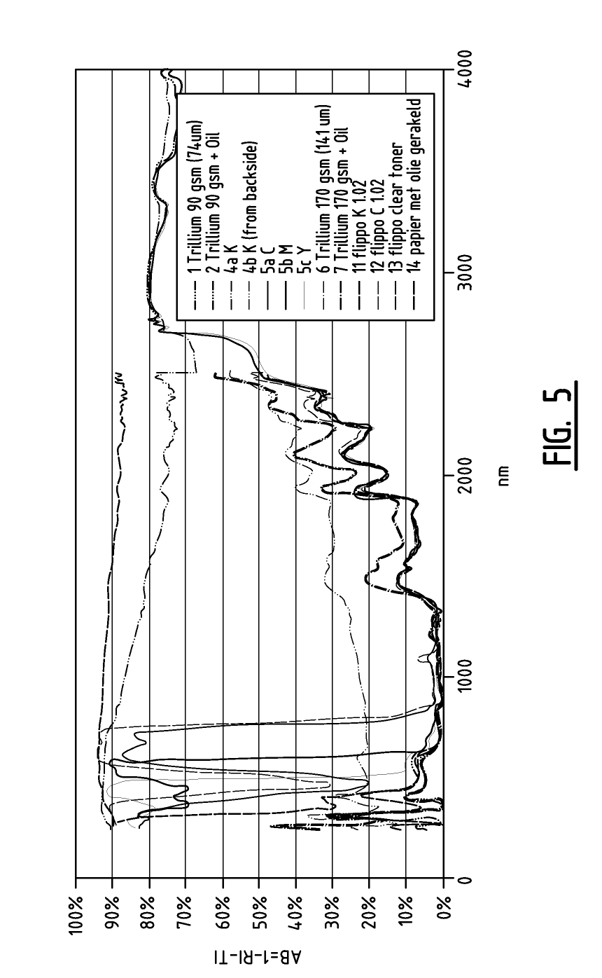

Embodiments of the invention are further based on the inventive insight that, above a predetermined threshold wavelength, the radiation absorption of the substrate increases with the wavelength, as illustrated in FIG. 5. The operation range of the conditioning unit 100 will allow obtaining on the one hand a sufficient amount of total radiated power with a relatively compact conditioning unit, whilst at the same time achieving a relatively high absorption of the radiation in the substrate. Also, because electromagnetic radiation is used to heat the substrate, the heat capacity of the conditioning unit 100 can be very low, so that the time needed to switch on/off the conditioning unit is very low.

In a preferred embodiment, the conditioning unit 100 is configured to emit radiation having a peak radiation wavelength λₘₐₓ for which the spectral density is maximal, between 1.4 μm and 5 μm, preferably between 2 μm and Sum. As can be seen in FIG. 5, such peak radiation wavelength values will guarantee a good absorption of the radiation by the paper substrate. On the other hand, the peak radiation wavelength λₘₐₓ may not be too high, because this would imply a relatively low operation temperature T, and hence, a low amount of total radiated power.

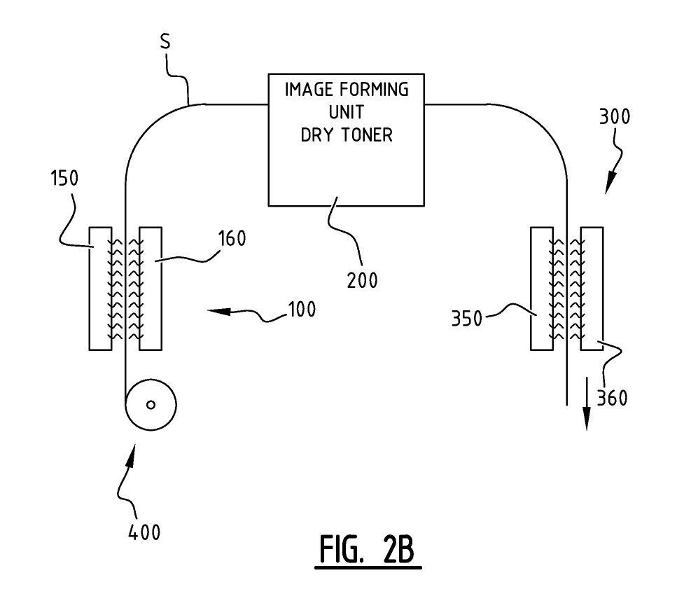

FIG. 2A illustrates a more detailed exemplary embodiment of an electrophotographic imaging apparatus according to the invention. In this exemplary embodiment it is assumed that the substrate S is a web which is unwound from a roll 400. Next, the substrate S is conveyed through a conditioning unit 100, e.g. a conditioning unit 100 as described in connection with FIG. 1. In the illustrated embodiment, the conditioning unit 100 comprises a top portion 150 and a lower portion 160. The lower portion 160 is configured to support and guide substrate S below the upper portion 150 which includes an infrared radiator. In other words, in the illustrated embodiment, only the top side of the substrate S is being radiated. However, a skilled person understands that it is possible to include infrared radiators in both the upper portion 150 and the lower portion 160. Also the conditioning unit 100 may be oriented vertically or may be slanted under an angle instead of horizontally. A vertical or inclined arrangement may be beneficial for the evacuation of humid air due to the evaporation of moisture from the substrate S.

In the exemplary embodiment of FIG. 2A, the image forming unit 200 uses liquid toner. Liquid toner, also called liquid toner dispersion, comprises carrier liquid, typically a substantially non-polar carrier liquid, and toner particles. Such substantially non-polar carrier liquids may be chosen from the following group: mineral oils, low or high viscosity liquid paraffins, isoparaffinic hydrocarbons, internal or terminal alkenes and polyenes, fatty acid glycerides, fatty acid esters or vegetable oils or combinations thereof. The term ‘substantially non-polar’ is used in the context of the application to encompass entirely non-polar materials such as alkanes and non-polar materials that are slightly more polar than alkanes, such as fatty acid based material that include a carboxyl-group.

The image forming unit 200 comprises a reservoir 210, a feed member 220, a development member 230, an imaging member 240, an intermediate member 250, and a transfer member 260. The substrate S is transported between intermediate member 250 and transfer member 260. Without loss of generality, the aforementioned members are illustrated and described as rollers, but the skilled person understands that they can be implemented differently, e.g. as belts.

In operation, an amount of liquid toner dispersion, initially stored in the liquid toner dispersion reservoir 210, is applied via feed member 220, to development member 230, imaging member 240, and optional intermediate member 250, and finally to the substrate S. Development member 230, imaging member 240, and intermediate member 250 all transfer part of the liquid toner dispersion adhering to their surface to their successor. The part of the liquid toner dispersion that remains present on the member's surface, i.e. the excess liquid toner dispersion, which remains after selective, imagewise transfer, may be removed after the transfer stage by appropriate removal means such as a scraper and may be recycled. The charging of the toner particles on the development member 230 is done by a charging device (not shown), e.g. a corona or a biased roll. Charging the toner particles causes the liquid toner dispersion to split into an inner layer at the surface adjacent of the development member 230 and an outer layer. The inner layer is richer in toner particles and the outer layer is richer in carrier liquid.

After transfer of the image on the substrate S in the image forming unit 200, fusing is carried out by means of a fusing unit 300. In the example of FIG. 2A, the fusing unit 300 is a non contact IR fusing unit. Optionally, the non-contact fusing unit 300 may be used in combination with a contact fusing unit (not shown). The non-contact fusing unit 300 causes coalescence of the toner particles, resulting in the formation of a film that is adhered to the substrate S and liberation of carrier liquid. The optional contact fusing unit (not illustrated) may remove the carrier liquid created during the coalenscence, enhance the adhesion and improve gloss of the film. The term ‘coalescence’ refers herein to the process wherein toner particles melt together and form a film or continuous phase that adheres well to the recording medium and that is separated from any carrier liquid.

Typically, the above described conditioning and imaging process occurs at “high speed”, for instance more than 50 cm/s, and up to 3 m/s or more, so as to enable high-speed printing.

It will be understood that for duplex and multicolour printing several image forming units 200 and fusing units 300 are typically available.

In a preferred embodiment, the fusing unit 300 is similar to the conditioning unit and is also configured to emit radiation having a wavelength between 1 μm and 5 μm to the substrate on which an image has been printed. The fusing unit 300 may comprise at least one infrared radiator which is configured to operate at a temperature between 500° C. and 1500° C., preferably between 500° C. and 1200° C., and more preferably between 550° C. and 1000° C. In the illustrated embodiment, the fusing unit has a lower part 360 and an upper part 350, and the upper part 350 comprises an infrared radiator. In case of duplex printing, and if both sides of the substrate are printed on in the same pass, it may be advantageous to include an infrared radiator in both parts 360, 350. Also the fusing unit 300 may be oriented vertically or under an angle instead of horizontally. A vertical or slanted arrangement may be beneficial for the evacuation of humid air due to the evaporation of moisture from the substrate.

FIG. 2B illustrates an exemplary embodiment of an electrophotographic imaging apparatus using dry toner. The substrate S is a web which is unwound from a roll 400. Next, the substrate S is conveyed through a conditioning unit 100, e.g. a conditioning unit 100 as described in connection with FIG. 1. In the illustrated embodiment, the conditioning unit 100 comprises a first portion 150 and a second portion 160. The second portion 160 and the first portion 150 both include an infrared radiator. In this embodiment the conditioning unit 100 is oriented vertically, i.e. the infrared radiators 150, 160 extend in a vertical direction along the substrate S. Such a vertical arrangement is beneficial for the evacuation of humid air due to the evaporation of moisture from the substrate S.

After transfer of images on the substrate S, e.g. images on a both sides of the substrate S, in the image forming unit 200, fusing is carried out by means of a fusing unit 300. In a preferred embodiment, the fusing unit 300 is similar to the conditioning unit 100 and is also configured to emit radiation having a wavelength between 1 μm and 5 μm to the substrate on which an image has been printed. The fusing unit 300 may comprise at least one infrared radiator which is configured to operate at a temperature between 500° C. and 1500° C., preferably between 500° C. and 1200° C., and more preferably between 550° C. and 1000° C. In the illustrated embodiment, the fusing unit has a second part 360 and a first part 350, and both the first and second part 350, 360 comprises an infrared radiator. Alternatively there may be provided a plurality of fusing units 300 in series, and/or a fusing unit 300 may comprise only one infrared radiator in one of the parts 350, 360.

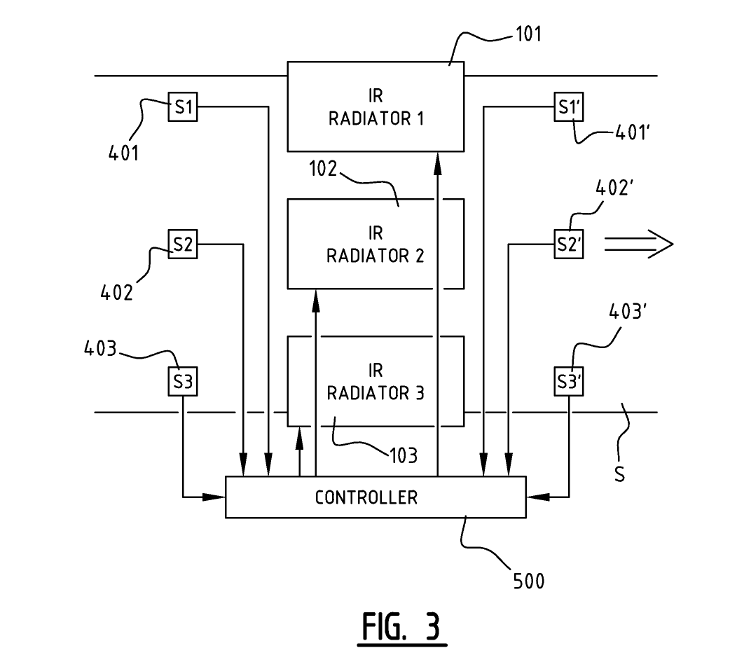

FIG. 3 illustrates a further developed exemplary embodiment of a conditioning unit for use in an electrophotographic imaging apparatus of the invention. In this embodiment, the conditioning unit comprises a first infrared radiator 101, a second infrared radiator 102, and a third infrared radiator 103. These three infrared radiators 101, 102, 103 are positioned adjacent to each other seen in a transverse direction perpendicular to the direction of movement of the substrate S. The conditioning unit further comprises a first moisture content sensor 401, a second moisture content sensor 402, and a third moisture content sensor 403. The first, second and third moisture content sensors 401, 402, 403 are configured to measure values representative for moisture content. It is noted that these values will typically not be values for the moisture content itself, but values for a property representative for moisture content such as an electrical property. The moisture content sensor 401, 402, 403 may be e.g. a sensor configured for measuring the electrostatic discharge behaviour of the substrate. The first moisture content sensor 401 is associated with the first infrared radiator 101, and is arranged in a first position upstream of the first infrared radiator 101. Alternatively or in addition, there may be provided a first moisture content sensor 401′ downstream of the first infrared radiator 101. The second and third moisture content sensors 402, 403 are associated with the second and third infrared radiators 102, 103, respectively, and are arranged in a second and third position upstream of the second and third infrared radiator 102, 103, respectively. In a similar manner, there may be provided a second and third sensor 402′, 403′ downstream of the second and third radiator 102, 103, respectively, instead of second and third sensor 402, 403, or in addition to second and third sensor 402, 403. The first, second and third position are located at a distance of each other seen in the transverse direction perpendicular to the direction of movement of the substrate S. Further, there is provided a controller 500 configured to control the first, second and third infrared radiators 101, 102, 103 in function of the measured content by the first, second and third moisture sensors 401, 402, 403, and/or in function of the measured values by the first, second and third moisture sensors 401′, 402′, 403′. Each infrared radiator 101, 102, 103 may be configured as described above in connection with the embodiment of FIG. 1, and more in particular, may be configured to operate at a temperature between 500° C. and 2500° C., preferably between 550° C. and 1500° C., more preferably between 600° C. and 1000° C.

By providing a plurality of infrared radiators 101, 102, 103 adjacent to each other seen in the transverse direction of the substrate S, and by providing a controller 500 which can control those infrared radiators 101, 102, 103 independently, differences in moisture content in the substrate can be adequately dealt with. The inventors discovered that due to storage of substrate rolls in a vertical position, the moisture content between the left and right side of the substrate may vary significantly. In other words, the moisture content may vary significantly in the transverse direction of the substrate S. Using the embodiment of FIG. 3, these differences between moisture content can be compensated by adjusting the heating by the infrared radiators 101, 102, 103, such that parts of the substrate S with the highest moisture content are heated more than parts of the substrate with the lowest moisture content.

The implementation of FIG. 3 may also be used in an exemplary embodiment of a fusing unit for use in an electrophotographic imaging apparatus of the invention. In this embodiment, the fusing unit comprises a first infrared radiator 101, a second infrared radiator 102, and a third infrared radiator 103. These three infrared radiators 101, 102, 103 are positioned adjacent to each other seen in a transverse direction perpendicular to the direction of movement of the substrate S. The fusing unit further comprises a first temperature sensor 401′, a second temperature sensor 402′, and a temperature sensor 403′. The first temperature sensor 401′ is associated with the first infrared radiator 101, and is arranged in a first position downstream of the first infrared radiator 101. Alternatively or in addition, there may be provided a first temperature sensor 401 upstream of the first infrared radiator 101. The second and third temperature sensors 402′, 403′ are associated with the second and third infrared radiators 102, 103, respectively, and are arranged in a second and third position downstream of the second and third infrared radiator 102, 103, respectively. In a similar manner, there may be provided a second and third sensor 402, 403 upstream of the second and third radiator 102, 103, respectively, instead of second and third sensor 402′, 403′, or in addition to second and third sensor 402′, 403′. The first, second and third position are located at a distance of each other seen in the transverse direction perpendicular to the direction of movement of the substrate S. Further, there is provided a controller 500 configured to control the first, second and third infrared radiators 101, 102, 103 in function of the measured temperature by the first, second and third sensors 401′, 402′, 403′, and/or in function of the measured values by the first, second and third moisture sensors 401, 402, 403. Each infrared radiator 101, 102, 103 may be configured as described above in connection with the fusing unit 300 of the embodiment of FIGS. 2 and 3, and more in particular, may be configured to operate at a temperature between 500° C. and 1500° C., preferably between 550° C. and 1200° C., more preferably between 600° C. and 1000° C. By providing a plurality of infrared radiators 101, 102, 103 adjacent to each other seen in the transverse direction of the substrate S, and by providing a controller 500 which can control those infrared radiators 101, 102, 103 independently, differences in temperature in the substrate can be adequately dealt with.

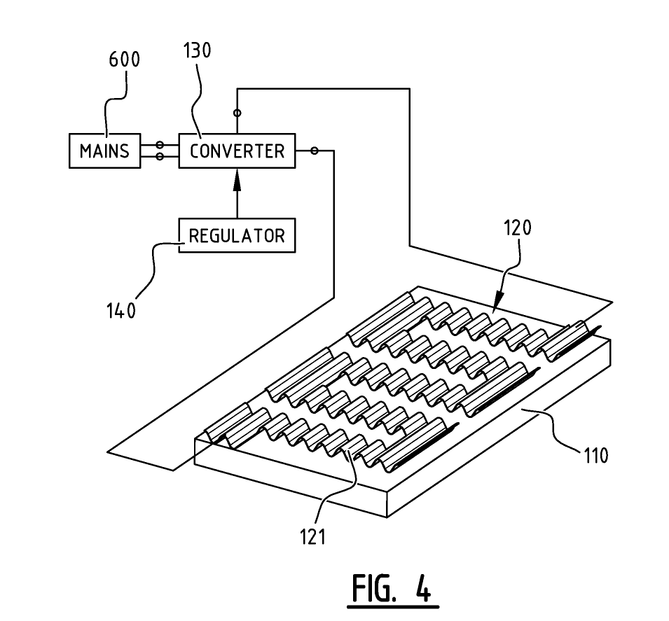

Now a more detailed exemplary embodiment of a conditioning or fusing unit comprising an infrared radiator will be described with reference to FIG. 4. In the embodiment of FIG. 4, the infrared radiator comprises a metal sheet 120 attached to a ceramic substrate 110, e.g. a ceramic substrate comprising calcium silicate. The metal sheet, e.g. a nickel sheet 120 is shaped such that a plurality of interconnected corrugated strips is formed. These strips 121 are corrugated in order to allow for expansion of the strips. Optionally, the metal sheet 120 may be coated. An alternating current, e.g. a 50 or 60 Hz signal is sent through the series connection of strips 121, and the material of the metal sheet 120 is such that the alternating current heats up the metal sheet 120 to a temperature between e.g. 600° C. and 900° C., at which temperature the metal sheet 120 emits radiation with a spectral density having a peak wavelength between 2 μm and 3 μm. The infrared radiator further comprises a converter 130 to convert a voltage of the mains supply voltage 600 into a suitable alternating voltage/current. Also, there may be provided a regulator 150 to adjust the duty cycle of the alternating voltage/current used to power the infrared radiator. To regulate the duty cycle without creating disturbing high harmonics on the signal of the mains, typically only some alterations of the AC signal are transmitted, whilst other alternations are not transmitted. This regulator 140 may be controlled by the controller 500 which has been discussed in connection with FIG. 3. In other words, the duty cycle may be further controlled in function of the measured values for moisture content, i.e. in function of the required heating. An example of a suitable metal sheet that may be used in embodiments of the invention is disclosed in European patent application EP 2 763 497, which is included herein by reference.

In exemplary embodiments the thickness of the metal strips 121 is preferably smaller than 2 mm, more preferably smaller than 1 mm, and most preferably smaller than 0.5 mm, e.g between 0.05 mm and 3 mm. The metal sheet 120 may comprise a pattern with a plurality of strips 121 connected in series, wherein the plurality of strips 121 has a width between 5 mm and 20 mm, and the total length of the plurality of strips is larger than 1 m (in the present example five strip each having a length which is larger than 200 mm), preferably larger than 2 m. Preferably the pattern is such that the strips create a more or less rectangular radiating surface.

Such embodiments will allow having a relatively small heat capacity per surface area seen by the substrate, so that the temperature of the metal body can decrease fast when switching off the power supply. Indeed, if it is assumed that e.g. the width is 10 mm, the thickness is 0.25 mm and the total length 2 m, then the heat capacity per surface area seen by the print substrate can be estimated as follows:

total surface area A is approximately 2000 mm*10 mm=0.02 m²;

the weight of the nickel metal sheet with density 8.9 kg/dm³ can be estimated as m=2 dm²*0.25 mm*8.9 kg/dm³=0.0445 kg;

thermal capacity nickel cₚ=460 J/kg·K;

resulting in a thermal capacity per surface area seen by the print substrate of (m*cₚ)/A=0.0445 kg*460 J/kgK/(0.02 m²)=1023.50 J/m²K

This value can be further decreased by using thinner metal sheets or by distributing the radiating metal sheet over a larger surface, e.g. by inserting more space between the strips 121. This value may be slightly higher due to the presence of the ceramic substrate 110, but is much lower than the thermal capacity of ceramic tiles used in the prior art embodiments to condition paper substrates.

In other non-illustrated embodiments infrared lamps may be used as the one or more IR radiators. Examples of suitable IR lamps are carbon IR lamps and fast response medium wave (FRMW) IR lamps. Such lamps typically operate at temperature between 1000° C. and 2000° C.

A person of skill in the art would readily recognize that steps performed by a controller in various above-described embodiments can be performed by programmed computers. Herein, embodiments are also intended to cover program storage devices, e.g., digital storage media, which are machine or computer readable and encode machine-executable or computer-executable programs of instructions for performing some or all of the above-described steps. The functions of the various elements shown in the figures, including any functional blocks labelled as “controller”, may be provided through the use of dedicated hardware as well as hardware capable of executing software in association with appropriate software. When provided by a controller, the functions may be provided by a single dedicated controller, or by a plurality of individual controllers, some of which may be shared.

Whilst the principles of the invention have been set out above in connection with specific embodiments, it is to be understood that this description is merely made by way of example and not as a limitation of the scope of protection which is determined by the appended claims.

1. An electrophotographic imaging apparatus comprising:
a conditioning unit configured to heat a substrate; and
an image forming unit configured to develop an image and to transfer the developed image to the heated substrate, said image forming unit being located downstream of the conditioning unit;
wherein the conditioning unit is configured to emit radiation having a wavelength between 1 micrometre and 5 micrometre, to the substrate, and wherein said conditioning unit comprises at least one infrared radiator which is configured to operate at a temperature between 500 and 2500 degrees Celsius.

2. The electrophotographic imaging apparatus of claim 1, wherein the conditioning unit is configured to emit radiation having a peak radiation wavelength
$${λ}_{max} = \frac{2900 µm . K}{T}$$
between 1.4 micrometre and 5 micrometre, preferably between 2 and 4 micrometre.

3. The electrophotographic imaging apparatus of claim 1, wherein the conditioning unit comprises at least one infrared radiator which is configured to operate at a temperature between 500 and 2500 degrees Celsius, preferably between 500 and 1500 degrees Celsius, and more preferably between 550 and 1000 degrees Celsius.

4. The electrophotographic imaging apparatus of claim 3, wherein the at least one infrared radiator comprises a metal body configured to emit radiation when a voltage is applied over the metal body, and wherein the temperature of the metal body is between 500 and 2500 degrees Celsius during radiation.

5. The electrophotographic imaging apparatus of claim 4, wherein the at least one infrared radiator comprises a resistive heater with a metal sheet, optionally a coated metal sheet.

6. The electrophotographic imaging apparatus of claim 4, wherein the at least one infrared radiator comprises a resistive heater with metal wires, optionally coated metal wires.

7. The electrophotographic imaging apparatus of claim 1, wherein the at least one infrared radiator has a heat capacity per surface area between 50 and 2000 J/m²K, preferably between 50 and 1500 J/m²K, more preferably between 50 and 1000 J/m²K.

8. The electrophotographic imaging apparatus of claim 1, wherein the conditioning unit comprises a converter circuit for converting a mains voltage in an alternating voltage/current for powering the at least one infrared radiator; and a regulator for regulating a duty cycle of the alternating voltage/current.

9. The electrophotographic imaging apparatus of claim 1, further comprising at least one sensor configured for measuring a value representative for moisture content in the print substrate before and/or after the print substrate has passed through the conditioning unit; and a controller configured to control the conditioning unit in function of the measured value by the at least one sensor.

10. The electrophotographic imaging apparatus of claim 9, wherein at least a first and a second sensor configured for measuring values representative for moisture content in the print substrate, are provided at a distance of each other seen in a transverse direction perpendicular on a movement direction of the substrate through the electrophotographic imaging apparatus; wherein the conditioning unit comprises at least a first infrared radiator and a second infrared radiator located adjacently of each other seen in the transverse direction; and wherein the controller is configured to control the first and second infrared radiator in function of the measured values by the first and second sensor.

11. An electrophotographic imaging apparatus comprising:
a conditioning unit configured to heat a substrate;
an image forming unit configured to develop an image and to transfer the developed image to the heated substrate, said image forming unit being located downstream of the conditioning unit;
at least a first sensor and a second sensor configured for measuring values representative for moisture content in the print substrate at a first location and at a second location, respectively, wherein the first location is at a distance of the second location seen in a transverse direction perpendicular on a movement direction of the substrate through the electrophotographic imaging apparatus;
wherein the conditioning unit comprises at least a first heater and a second heater located adjacently of each other seen in the transverse direction; and
a controller configured to control the first and second heater in function of the measured values by the first and second sensor.

12. The electrophotographic imaging apparatus of claim 11, wherein the first and second sensor are configured for measuring at least one of the following:
values representative for moisture content in the substrate between the conditioning unit and the image forming unit; and
values representative for moisture content in the substrate upstream of the conditioning unit.

13. The electrophotographic imaging apparatus of claim 11, wherein the conditioning unit is configured to emit radiation having a wavelength between 1 micrometre and 5 micrometre, to the substrate, wherein the first and second heater are a first and second infrared radiator which are configured to operate at a temperature between 500 and 2500 degrees Celsius.

14. The electrophotographic imaging apparatus of claim 11, wherein the conditioning unit is configured to emit radiation having a peak radiation wavelength between 1.4 micrometre and 5 micrometre, preferably between 2 and 4 micrometre.

15. The electrophotographic imaging apparatus of claim 11, wherein the first and second infrared radiators are configured to operate at a temperature between 500 and 1500 degrees Celsius, preferably between 550 and 1000 degrees Celsius; and/or
wherein the first and second infrared radiator each comprise a resistive heater with a metal sheet, optionally a coated metal sheet; and/or
wherein the conditioning unit comprises a first and second converter circuit for converting a mains voltage in an alternating voltage/current for powering the first and second infrared radiator, respectively, and a first and second regulator for regulating a duty cycle of the alternating voltage/current.

16. An electrophotographic imaging apparatus comprising:
an image forming unit configured to develop an image and to transfer the developed image to a substrate; and
a fusing unit configured to fuse the transferred image on the substrate;
wherein the fusing unit is configured to emit radiation having a wavelength between 1 micrometre and 5 micrometre, to the substrate, wherein said fusing unit comprises at least one infrared radiator which is configured to operate at a temperature between 500 and 1200 degrees Celsius.

17. The electrophotographic imaging apparatus of claim 16, wherein the fusing unit is configured to emit radiation having a peak radiation wavelength
$${λ}_{max} = \frac{2900 µm . K}{T}$$
between 1.4 micrometre and 5 micrometre, preferably between 1.9 and 4 micrometre.

18. The electrophotographic imaging apparatus of claim 16, wherein the fusing unit comprises at least one infrared radiator which is configured to operate at a temperature between 500 and 2500 degrees Celsius, preferably between 500 and 1500 degrees Celsius, and more preferably between 550 and 1000 degrees Celsius.

19. The electrophotographic imaging apparatus of claim 18, wherein the at least one infrared radiator comprises a resistive heater with a metal body configured to emit radiation when a voltage is applied over the metal body, and wherein the temperature of the metal body is between 500 and 2500 degrees Celsius during radiation, preferably between 500 and 1500 degrees Celsius, and more preferably between 550 and 1000 degrees Celsius.

20. The electrophotographic imaging apparatus of claim 19, wherein the at least one infrared radiator is at least one of the following:
a resistive heater with a metal sheet, optionally a coated metal sheet; and
a resistive heater with metal wires, optionally coated metal wires.
